(19) United States
(12) Patent Application Publication
(10) Pub. No.: US 2022/0229390 A1
(43) Pub. Date: Jul. 21, 2022

(54) IMAGE FORMING APPARATUS

(71) Applicant: CANON KABUSHIKI KAISHA, Tokyo (JP)

(72) Inventor: Ryo Aihara, Chiba (JP)

(21) Appl. No.: 17/543,831

(22) Filed: Dec. 7, 2021

(30) Foreign Application Priority Data
Jan. 18, 2021 (JP) 2021-005876

(51) Int. Cl. G03G 15/00; B65H 5/06; B65H 7/02

(52) U.S. Cl. CPC G03G 15/6502; B65H 7/02; B65H 5/062

(57) ABSTRACT

An image forming apparatus includes an image forming portion, a sheet feeding portion, a first guiding member, a second guiding member, a driving portion, a detecting portion, and a controller. When a leading end of a sheet is detected by the detecting portion, in a case that information on a thickness of the sheet fed by the sheet feeding portion is a first thickness, the controller controls the driving portion so that a distance in a sheet feeding passage with respect to a thickness direction is a first distance, and in a case that the information on the thickness of the sheet fed by the sheet feeding portion is a second thickness thinner than the first thickness, the controller controls the driving portion so that the distance in the sheet feeding passage with respect to the thickness direction is a second distance shorter than the first distance.

### FIELD OF THE INVENTION AND RELATED ART

The present invention relates to an image forming apparatus for forming an image on a sheet.

In the image forming apparatus of an electrophotographic type or the like, a constitution in which different images are formed on a first surface (front surface) and a second surface (black surface), respectively, of the sheet is employed. In such an image forming apparatus, the image is formed on a first surface, and thereafter, and leading and trailing ends of the sheet are reversed, and the image is formed on the second surface. By this sheet reversing operation, the trailing end of the sheet becomes the leading end of the sheet. That is, in the case where the image is formed on the first surface of the sheet, the image is formed on the sheet by being aligned with a sheet leading end position on the first surface of the sheet. On the other hand, in the case where the image is formed on the sheet, the image is formed on the second surface of the sheet, the image is formed on the sheet by being aligned with a sheet leading end position (sheet trailing end position on the first surface of the sheet) on the second surface of the sheet.

In order to accurately align an image forming position of the first surface of the sheet with an image forming position of the second surface of the sheet, in Japanese Laid-Open Patent Application 2018-72538, a technique such that a plurality of reference images for adjusting the positions are formed on the sheet and are read by a scanner, and then the positions where the images are formed are adjusted depending on a difference between the positions of these reference images is disclosed.

However, for example, in the case where the sheet fed is a thin sheet and a leading end of the sheet is curled, even when the reference image positions are adjusted in the above, there is a liability that a distance from the leading end to the image position varies by an amount of the curl. For that reason, in order to suppress the amount of the curl, when a thickness (distance between guiding members) of a sheet feeding passage is set at a small value, a thick sheet causes a jam, and therefore, there is a problem that such setting cannot meet the thick sheet. On the other hand, in order to prevent the occurrence of the jam of the thick sheet, when the thickness of the sheet feeding passage is set at a large value in conformity to the thick sheet, there arises a problem that accuracy of the positional alignment of the thin sheet becomes unsatisfactory.

### SUMMARY OF THE INVENTION

A principal object of the present invention is to provide an image forming apparatus capable of detecting a position of a thin sheet with accuracy while enabling even a thick sheet to be subjected to image formation.

According to an aspect of the present invention is to provide an image forming apparatus comprising: an image forming portion configured to form an image on a sheet; a sheet feeding portion configured to feed the sheet toward the image forming portion; a first guiding member provided between the sheet feeding portion and the image forming portion and including a first guiding surface for guiding the sheet; a second guiding member configured to form a sheet feeding passage in which the sheet passes, by being provided opposed to the first guiding member and including a second guiding surface for guiding the sheet; a driving portion configured to movably drive the first guiding portion so that a distance in the sheet feeding passage with respect to a thickness direction of the sheet changes; a detecting portion provided downstream of the sheet feeding portion with respect to the feeding direction and configured to detect a leading end of the sheet at a detecting position; and a controller configured to control a time until the leading end of the sheet reaches from the detecting position of the detecting portion to the image forming portion by controlling the sheet feeding portion on the basis of a detection result of the leading end of the sheet by the detecting portion, wherein when the leading end of the sheet is detected by the detecting portion, in a case that information on a thickness of the sheet fed by the sheet feeding portion is a first thickness, the controller controls the driving portion so that the distance in the sheet feeding passage with respect to the thickness direction is a first distance, and in a case that the information on the thickness of the sheet fed by the sheet feeding portion is a second thickness thinner than the first thickness, the controller controls the driving portion so that the distance in the sheet feeding passage with respect to the thickness direction is a second distance shorter than the first distance.

Further features of the present invention will become apparent from the following description of exemplary embodiments with reference to the attached drawings.

### BRIEF DESCRIPTION OF THE DRAWINGS

FIG. 1 is a schematic view of an image forming system according to a first embodiment.

FIG. 2 is an enlarged sectional view showing a feeding passage, in which a timing sensor is provided, from a registration roller pair to a transfer portion.

FIG. 3 is an enlarged schematic view showing the feeding passage in which the timing sensor is disposed and the registration roller pair.

FIG. 4A is a schematic view showing a state in which a thin sheet which is not curled is fed in a state in which a moving feeding guide is kept at a longest distance from a fixed feeding guide.

FIG. 4B is a schematic view showing a state in which a thin sheet which is curled is fed in the state in which the moving feeding guide is kept at the longest distance from the fixed feeding guide.

FIG. 4C is a schematic view showing a state in which the thin sheet is fed in a state in which the moving feeding guide is brought near to the fixed feeding guide for the thin sheet.

FIG. 5 is a sectional view showing the fixed feeding guide and the moving feeding guide in a position of the timing sensor according to the first embodiment.

FIG. 6 is a block diagram showing a control system of the image forming apparatus according to the first embodiment.

FIG. 7 is a flowchart showing feeding passage thickness control according to the first embodiment.

FIG. 8A is a sectional view showing a fixed feeding guide and a moving feeding guide in a position of a timing sensor according to a second embodiment.

FIG. 8B is an enlarged schematic view showing a driving mechanism according to the second embodiment.

FIG. 9 is a sectional view showing a fixed feeding guide and a moving feeding guide in a position of a timing sensor according to a third embodiment.

### DESCRIPTION OF THE EMBODIMENTS

In the following, an image reading apparatus and an image forming system according to respective embodiments will be described while making reference to the drawings. As regards dimensions, materials, shapes, and relative arrangements of constituent elements described in the following embodiments, an application range of the present invention is not intended to be limited only thereto unless otherwise specified.

### First Embodiment

[General Structure of Image Forming System]

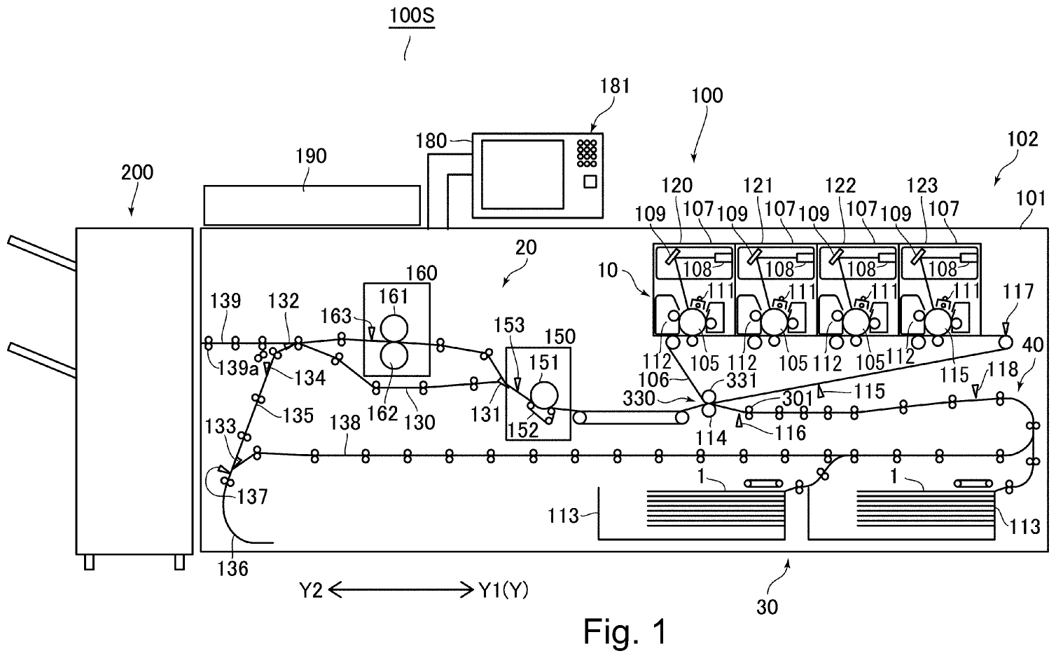

FIG. 1 is a schematic view of an image forming system 100S according to a first embodiment. The image forming system 100S includes an image forming apparatus 100 and a finisher 200. In this embodiment, as the image forming apparatus, the image forming apparatus 100 which is a laser beam printer of an electrophotographic type will be described as an example, but is not limited thereto. The image forming apparatus may also be a printer of an ink jet type or a printer of a sublimation type.

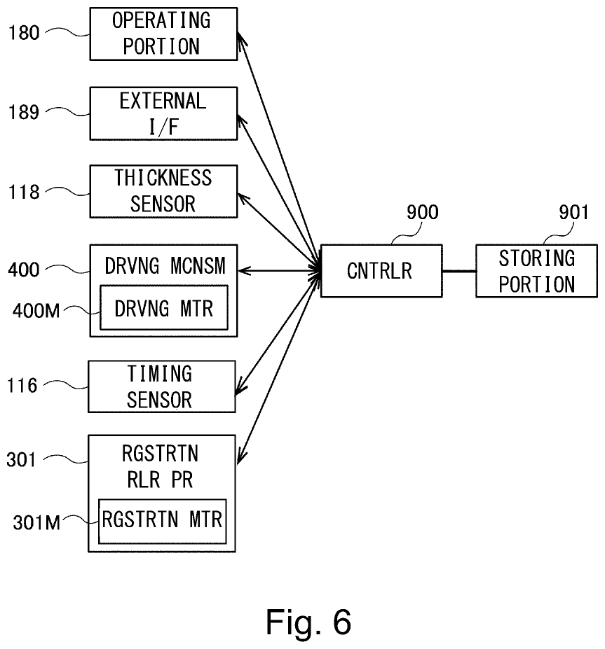

In a casing 101 of the image forming apparatus 100, an image forming engine 102, a controller 900 for controlling an operation of the image forming system 100S, and a control board accommodating portion for accommodating a storing portion 901 (see FIG. 6) which is a data storing area are mounted. The image forming engine 102 as an image forming portion includes an optical processing mechanism 10 and a fixing processing mechanism 20 which are used for forming an image on a recording material by an image forming process, and includes a feeding processing mechanism 30 and a conveying processing mechanism 40 which are used for feeding and conveying a rectangular sheet 110 used as the recording material. As the recording material, it is possible to use sheets including papers such as plain paper and thick paper, surface-treated papers such as coated paper and embossed paper, a plastic film, a cloth, and the like.

The optical processing mechanism 10 includes stations 120, 121, 122 and 123 for forming toner images of colors of yellow, magenta, cyan and black, respectively, and an intermediary transfer belt 106. In each of the stations 120-123, a surface of a photosensitive member 105 which is a drum-shaped photosensitive member is electrically charged by a primary charger 111. A laser scanner portion 107 performs an exposure processing of the photosensitive member 105 on the basis of an instruction signal which is generated based on image data and which is sent to the laser scanner portion 107. The laser scanner portion 107 includes a laser driver for turning on and off laser light emitted from a semiconductor laser. The laser scanner portion 107 guides the laser light from the semiconductor laser toward the photosensitive member 105 via a reflecting mirror 109 while dividing the laser light (beams) in a main scan direction (widthwise direction of the sheet) by a rotatable polygonal mirror. By this, an electrostatic latent image corresponding to the image data is formed on the surface of the photosensitive member 105.

A depending device 112 accommodates there is a developer containing toner and supplies charged toner particles to the photosensitive member 105. The toner particles are deposited on the drum surface depending on a surface potential distribution, so that the electrostatic latent image carried on the photosensitive member 105 is visualized as a toner image. The toner image carried on the photosensitive member 105 is transferred (primary-transferred) onto the intermediary transfer belt 106 to which a voltage of a polarity opposite to a normal charge polarity of the toner is applied. In the case where a color image is formed, the toner images formed by the four stations 120-123 are multiple-transferred so as to be superposed on each other on the intermediary transfer belt 106, so that a full-color toner image is formed on the belt.

On the other hand, the feeding processing mechanism 30 feeds sheets 110 one by one from a sheet accommodating portion 113, inserted into the casing 101 of the image forming apparatus 100 so as to be capable of being pulled out of the casing, toward a transfer portion 330 formed by a transfer roller 114 and an inner transfer roller 331. As described later specifically, a leading end of the sheet 110 fed is detected by a timing sensor 116 as a detecting portion. The controller 900 controls a timing when a feeding (conveying) speed of the sheet 110 by a registration roller pair 301 on the basis of detection of a leading end of the sheet 110 as a detection result of the timing sensor 116 is lowered, and thus adjusts a timing when the leading end of the sheet 110 reaches the transfer portion 330. Then, the toner image carried on the intermediary transfer belt 106 which is an intermediary transfer member is transferred (secondary-transferred) onto the sheet 110.

Around the intermediary transfer belt 106, an image formation start position detecting sensor 115 for determining a print start position when image formation is performed, the timing sensor 116 for establishing a timing when the sheet 110 is fed, and a density sensor 117 are provided. The density sensor 117 measures a density of a patch image for a test carried on the intermediary transfer belt 106. The controller 900 adjusts an operation condition (for example, setting of a target charging potential of the primary charger 111 and a bias voltage of the developing device 112) of the optical processing mechanism 10 on the basis of a detection result of the density sensor 117.

The fixing processing mechanism 20 as a fixing portion in this embodiment is constituted by a first fixing device 150 and a second fixing device 160. The first fixing device 150 includes a fixing roller 151, a pressing belt 152 for causing the sheet 110 to press-contact the fixing roller 151, and a first post-fixing sensor 153 for detecting completion of fixing processing by the first fixing device 150. The fixing roller 151 is a hollow roller and includes a heater therein. The first fixing provided 150 applies heat and pressure to the toner image on the sheet 110 while nipping and feeding the sheet 110 by the fixing roller 151 and the pressing belt 152 which are a rotatable member pair. By this, the toner particles are melted and then are fixed, so that the image is fixed on the sheet 110.

The second fixing device 160 is disposed on a side downstream of the first fixing device 150 with respect to a feeding passage of the sheet 110. The second fixing device 160 has a function of enhancing glossiness of the image subjected to the fixing processing by the first fixing device 150 and of ensuring a fixing property of the image on the sheet 110. The second fixing device 160 includes a fixing roller 161 and a pressing roller 162 which are a rotatable member pair for heating and pressing the sheet 110 while feeding the sheet 110 similarly as the first fixing device 150, and a second post-fixing sensor 163 for detecting completion of fixing processing by the second fixing device 160.

Incidentally, there is a case that there is no need to pass the sheet 110 through the second fixing device 160 depending on a kind of the sheet 110. In such a case, the image forming apparatus 100 includes a detour feeding passage 130 for discharging the sheet 110 without via the second fixing device 160 for the purpose of reducing energy consumption. The sheet 110 sent from the first fixing device 150 is derived to either one of the second fixing device 160 and the detour feeding passage 130 by a first switching flapper 131.

The sheet 110 passed through the second fixing device 160 or the detour feeding passage 130 is derived to either one of a discharging feeding passage 139 and a reverse sheet 135 by a second switching flapper 132. The sheet 110 conveyed to the reverse feeding passage 135 is subjected to detection of a position of the sheet 110 by a reversing sensor 137, so that a downstream end (leading end) and an upstream end (trailing end) of the sheet 110 with respect to a sub-scan direction (sheet feeding direction) are switched to each other by a switch-back operation performed by a reversing portion 136. In the case of double-side printing, the sheet 110 on which the image is formed on the front surface is conveyed again toward the transfer roller 114 via a re-feeding (conveying) passage 138 by a third switching flap 133 in a state in which leading end trailing ends of the sheet 110 are changed to each other by the reversing portion 136, so that an image is formed on a back surface of the sheet 110 opposite from the front surface of the sheet 110.

The sheet 110 on which the image formation in one-side printing is ended or the sheet 110 on which the image formation on the back surface in the double-side printing is ended is discharged to an outside of the image forming apparatus 100 by a discharging roller 139a provided in a discharging feeding passage 139 and then is fed to the finisher 200. Between the reversing feeding passage 135 and the discharging feeding passage 139, a fourth flapper 134 capable of deriving the sheet 110, switched back by the reversing portion 136, toward the discharging feeding passage 139 is provided. That is, by this fourth flapper 134, the front and back surfaces (sides) of the sheet 110 when the sheet 110 is discharged from the image forming apparatus 100 is made selectable. Incidentally, at an upper portion of the image forming apparatus 100, an image reading device 190 for reading image information from an original is provided. Further, the finisher 200 carries out processing such that a plurality of the sheets 110 which are fed successively from the image forming apparatus 100 are discharged while being aligned and stored in bundles or are discharged after being subjected to stapling processing. Then, the sheets 110 are discharged to the outside of the finisher 200, so that the sheet discharging as the image forming system 100S is completed.

[General Structure of Feeding Passage from Registration Roller Pair to Transfer Portion]

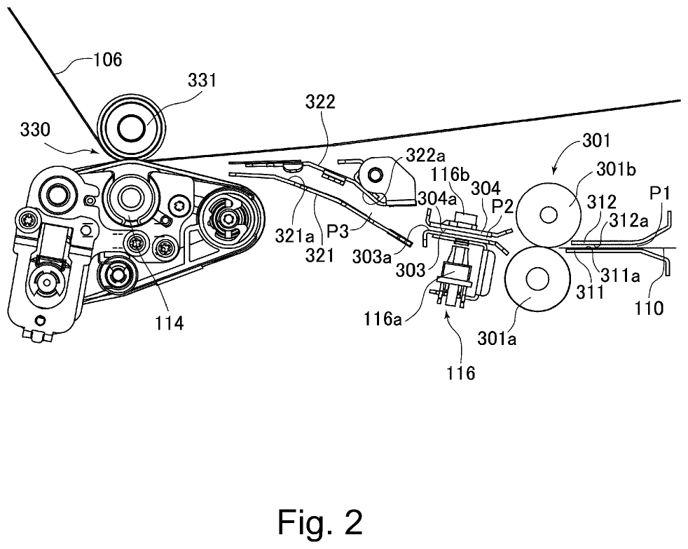

General structures of sheet feeding passages P1, P2 and P3 of the sheets, from the registration roller pair 301 to the transfer portion 330, in which the timing sensor 116 is disposed will be described using FIG. 2. FIG. 2 is an enlarged sectional view showing the feeding passages, from the registration roller pair 301 to the transfer potion 330, in which the timing sensor 116 is disposed. The sheet 110 fed from the sheet accommodating portion 113 or the reversing portion 136 passes through the feeding passage P1 formed between a feeding guide 311 including a guide surface 311a and a feeding guide 312 including a guide surface 312a and is fed to the registration roller pair 301. The registration roller pair 301 as a sheet feeding portion is constituted by including a driving roller 301a which is a first roller driven by a driving motor and a follower roller 301b which is a second roller driven by the driving roller 301a. The sheet 110 fed by a feeding force of the registration roller pair 301 is disposed on a downstream side of the sheet feeding direction and is fed to the feeding passage P2 in which the timing sensor 116 is disposed.

The feeding passage P2 is constituted by a fixed feeding guide 303 including a guide surface 303a constituting a second guiding surface and a moving feeding guide 304 including a guide surface 304a constituting a first guiding surface. That is, the feeding passage P2 is formed as a space in which the sheet 110 is capable of passing through between the guide surface 303a and the guide surface 304a disposed opposed to each other, and the fixed feeding guide 303 is disposed below the feeding passage P2 and the moving feeding guide 304 is disposed above the feeding passage P2. In the first embodiment, each of the guide surfaces 303a and 304a is larger in distance with respect to the widthwise direction than a maximum width size of the sheet with respect to the widthwise direction in which the image is capable of being formed in the image forming apparatus 100, in other words, in which the sheet is capable of being fed by the respective rollers. Accordingly, a constitution in which even when the maximum width size sheet is fed, the sheet falls within a range with respect to the widthwise direction, without projecting in the widthwise direction of the feeding passage P2, between the guide surface 303a and the guide surface 304a is employed.

The timing sensor 116 is constituted by including a sensor main body 116a as an element for emitting and receiving light and a prism 116b as a reflecting member for reflecting the light from the sensor main body 116a and for returning the light to the fixed feeding guide 303. The sensor main body 116a is fixed and supported by the fixed feeding guide 303. The prism 116b is fixed and supported by the moving feeding guide 304. Further, in the first embodiment, the fixed feeding guide 303 is fixed to a frame fixed to the casing 101, and the moving feeding guide 304 is supported movably by the frame.

Further, on a side downstream, with respect to the sheet feeding direction, of the feeding passage P2 formed by the fixed feeding guide 303 and the moving feeding guide 304, the feeding passage P3 is disposed. The feeding passage P3 is formed by a feeding guide 321 including a guide surface 321a and a feeding guide 322 including a guide surface 322a. That is, the feeding passage P3 is formed between the guide surface 321a and the guide surface 322a, and the feeding guide 321 is disposed below the feeding passage P3 and the feeding guide 322 is disposed above the feeding passage P3. This feeding passage P3 is disposed between the feeding passage P2 and the transfer portion 330 and is constituted so that the sheet 110 fed by the registration roller pair 301 is guided to the transfer portion 330. For that reason, the feeding passage P3 is formed so as to be curved as viewed in the widthwise direction of the sheet so that the sheet 110 is guided upward and is caused to approach the intermediary transfer belt 106 and then so that an angle between the intermediary transfer belt 106 and an advancing direction of the leading end of the sheet 110 is made small and then the sheet 110 reaches the transfer portion 330.

Incidentally, the widthwise direction of the sheet refers to a direction perpendicular to the sheet feeding direction and a sheet thickness direction, and refers to a direction parallel to axial directions of the various rollers.

### [Cause of Detection Error by Timing Sensor and Reduction of Error]

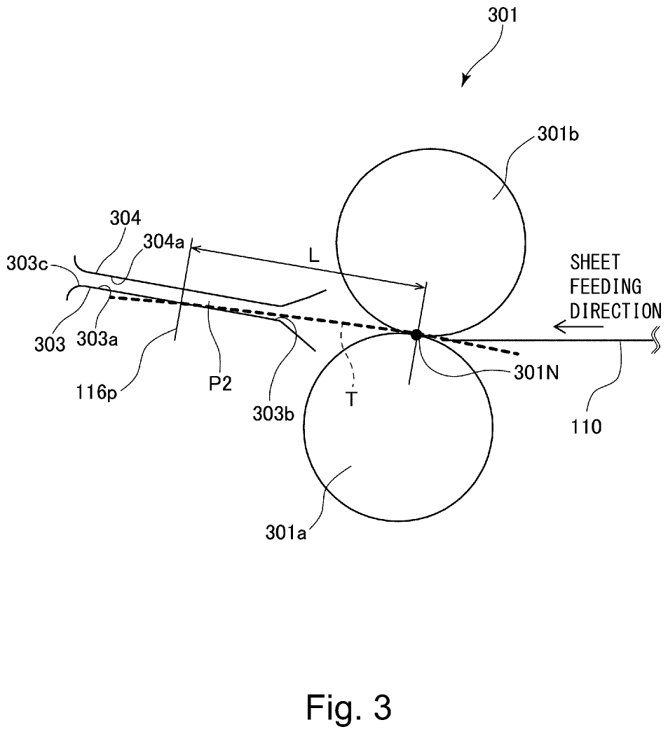

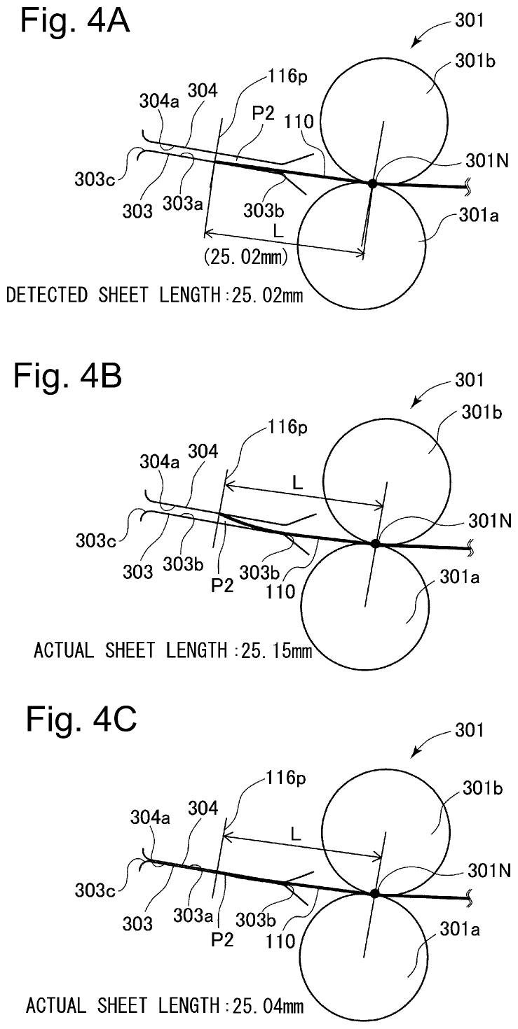

Next, a cause of an occurrence of an error of a timing (sheet feeding distance) when the leading end of the sheet 110 is detected by the timing sensor 116, and an error reducing constitution will be described using FIG. 3, FIG. 4A, FIG. 4B and FIG. 4C. FIG. 3 is an enlarged schematic view showing the feeding passage in which the timing sensor is disposed and showing the registration roller pair. FIG. 4A is a schematic view showing a state in which a thin sheet which is not curled is fed in a state in which the moving feeding guide is kept at a longest distance from the fixed feeding guide. FIG. 4B is a schematic view showing a state in which a thin sheet which is curled is fed in the state in which the moving feeding guide is kept at the longest distance from the fixed feeding guide. FIG. 4C is a schematic view showing a state in which the thin sheet is fed in a state in which the moving feeding guide is brought near to the fixed feeding guide for the thin sheet.

As shown in FIG. 3, in the registration roller pair 301, a nip 301N is formed at a position where the driving roller 301a and the follower roller 301b are in contact with each other. In other words, the nip 301N is formed at a point of intersection of a line connecting centers of the driving roller 301a and the follower roller and an outer periphery of each of these rollers. A distance from the nip 301N to a detecting position 116p where the timing sensor 116 detects the leading end of the sheet 110 is a length L.

A tangential line T passing through the nip 301N and contacting the driving roller 301a or the follower roller 301b is referred to as a phantom line. On the other hand, the guide surface 303a of the above-described fixed feeding guide 303 includes an upstream-side end portion 303b and a downstream-side end portion 303c with respect to the feeding direction. In the image forming apparatus 100 of this embodiment, the transfer portion 330 is disposed on one side (upper side) relative to the tangential line T (see FIG. 2). For that reason, as viewed in the widthwise direction, the downstream-side end portion 303c with respect to the feeding direction is positioned on one side (upper side) relative to the tangential line T, and the upstream-side end portion 303b with respect to the feeding direction is positioned on the other side (lower side) relative to the tangential line T. Further, the guide surface 303a is inclined relative to the tangential line T so that the nip 301N is positioned on a feeding passage P2 side. In summary, the guide surface 303a of the fixed feeding guide 303 is guided so that the leading end of the sheet 110 moves toward the transfer portion 330 positioned on one side (upper side) relative to the tangential line L. By this, as shown in FIG. 4A, if the sheet 110 is not curled, the leading end of the sheet 110 fed from the registration roller pair 301 is to be fed so as to contact and follow the guide surface 303a.

A state shown in FIG. 4A is a state in which a distance between the fixed feeding guide 303 and the moving feeding guide 304 is determined in conformity to a thickest sheet. In this state, a distance in the feeding passage P2 with respect to the thickness direction of the sheet, which is a distance between the guide surface 303a and the guide surface 304a (hereinafter, this distance is referred to as a “path interval”) is 1.5 mm. Here, for example, it is assumed that the surface 110 is thin paper and is 0.1 mm in thickness and that the sheet 110 does not cause curl, crease, and the like. When such a sheet 110 is fed by the registration roller pair 301, the leading end of the sheet 110 passes through a linear shortest passage along the above-described tangential line T and passes through the detecting position 116p of the timing sensor 116, and is detected by the timing sensor 116. At this time, an arrival distance from the nip 301N to the detecting position 116p of the timing sensor 116 is 25.02 mm.

A state shown in FIG. 4B is the same as the state shown in FIG. 4A in the path interval in the feeding passage P2, and is a state in which the sheet 110 is curled upward. In this state, it is assumed that the curl occurs at a position of 10 mm from the leading end of the sheet 110 toward the upstream side of the feeding direction. In this case, in a state in which the leading end of the sheet 110 reaches the detecting position 116p, the sheet 110 is fed from the nip 301N of the registration roller pair 301 by 25.15 mm. That is, at this point of time, a length of the sheet actually existing from the nip 301N to the detecting position 116p is 25.15 mm. The timing sensor 116 (controller 900 (see FIG. 6)) discriminates that the sheet 110 is linearly fed as shown in FIG. 4A and detects that the length is 25.02 mm as a value set in advance, so that an actual advance amount of the paper (sheet) is deviated by 0.13 mm at the maximum. For example, in the image forming apparatus in which offset printing is performed, printing can be performed in an error tolerable range for alignment of front and back surfaces (sides) of 0.2 mm. As regards such an error level, when an occurrence of a variation in alignment of front and back surfaces due to another factor such as moisture absorption of the paper or the like factor is taken into consideration, the error of 0.13 mm in detection of the leading end of the sheet is large as the error.

Therefore, in the first embodiment, as shown in FIG. 4C, the moving feeding guide 304 is moved depending on the thickness of the sheet 110, so that the path interval in the feeding passage P2 is adjusted. In the state shown in FIG. 4C, the sheet 110 is thin paper and the path interval in the feeding passage P2 is set at 0.3 mm. By this, even when the sheet 110 is curled, the curl is rectified by the fixed feeding guide 303 and the moving feeding guide 304. For that reason, at the point of time when the leading end of the sheet 110 reaches the detecting position 116p, the length of the sheet actually existing from the nip 301N to the detecting position 116p becomes 25.04 mm. Compared with the length of the sheet 110 in the case where the sheet 110 is not curled as shown in FIG. 4A, the deviation amount is 0.02 mm, so that the error can be reduced. That is, a variation in position of the leading end of the sheet 110 when the sheet 110 is detected can be made small. In other words, the position of the leading end of the sheet 110 can be detected with accuracy.

### [Constitution of Driving Mechanism of Feeding Guide and Control System]

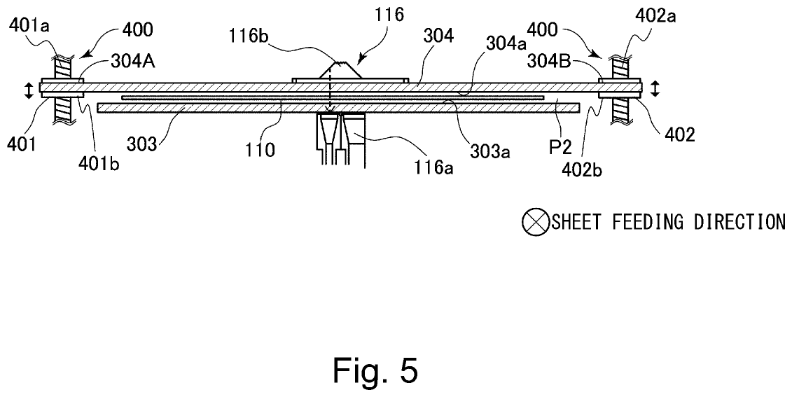

Then, a constitution of a control system of the image forming apparatus 100 will be described using FIG. 5 and FIG. 6. FIG. 5 is a sectional view showing the fixed feeding guide and the moving feeding guide in the position of the timing sensor according to the first embodiment. FIG. 6 is a block diagram showing the control system of the image forming apparatus according to the first embodiment.

As shown in FIG. 6, the image forming apparatus 100 includes the controller 900 for carrying out integrated control of an operation of the image forming apparatus 100 or the image forming system 100S (see FIG. 1) and the storing portion 901 for storing various data by being connected to the controller 900. Further, to the controller 900, an operating portion 180 (see FIG. 1), an external interface (I/F) 189, a sheet thickness sensor 118, a driving motor 400M of a driving mechanism 400, the above-described timing sensor 116, a registration motor 301M for the registration roller pair 301, and the like are connected.

The operating portion 180 is provided with a display as a displaying means for displaying information to a user. Further, the operating portion 180 is provided with, as a receiving potion capable of receiving instructions and data from the user to the image forming system 100S, for example, physical keys such as numerical keys and a print execution button and a touch panel function of the display. By an operation of the operating portion 180. The user is capable of inputting, to the storing portion 901 via the controller 900, information indicating sheet attributes such as a name, a basis weight execution or non-execution of surface treatment of the sheets set in a certain sheet accommodating portion 113.

Further, the controller 900 is connected to an external wired or wireless communication network via the interface (I/F) 189 as the receiving portion, and is capable of communicating with an external computer. That is, instead of the information inputted through the above-described operating portion 180, input of information from the external computer can be received by the controller 900. Further, the controller 900 is also connected to a control circuit for an apparatus (the finisher 200 in this embodiment) which is connected to the image forming apparatus 100 and which constitutes the image forming system 100S. The controller 900 establishes communication with these devices (apparatus) and causes the image forming apparatus 100 and the respective devices to be in cooperation with each other.

The sheet thickness sensor 118 as a thickness detecting portion is disposed on a sheet feeding passage connecting the sheet accommodating portion 113 or the reversing portion 136 with the registration roller pair 301 as shown in FIG. 1. The sheet thickness sensor 118 detects the thickness of the sheet 110 fed to the registration roller pair 301 (i.e., to the above-described feeding passage P2). Specifically, as the sheet thickness sensor 118, for example, an ultrasonic sensor for applying ultrasonic wave to the sheet 110 and for detecting attenuation of the ultrasonic wave can be used, but the sheet thickness sensor 118 is not limited thereto, and for example, one for measuring a displacement of the sheet 110 by bringing a movable member into contact with the sheet 110 may also be used.

Incidentally, the timing sensor 116 is a sensor for detecting that the leading end of the sheet 110 reaches the timing sensor 116 between the registration roller pair 301 and the transfer portion 330 with respect to the sheet feeding direction. Further, the registration motor 301M is a motor for driving the driving roller 301a of the registration roller pair 301. The controller 900 is capable of changing a feeding speed of the sheet 110 by controlling this registration motor 301M.

The driving mechanism 400 as a driving portion is a mechanism for moving the moving feeding guide 304 toward and away from the fixed feeding guide 303, i.e., for enabling drive of the moving feeding guide 304 so as to move in the widthwise direction of the sheet. The driving mechanism 400 is provided with a driving motor 400M (see FIG. 6) and direct-acting mechanisms 401 and 402 which are ball spring mechanisms each constituted by a ball spring. The direct-acting mechanisms are constituted by including screw shafts 401a and 402a, respectively, and nuts 401b and 402b, respectively. The nut 401b is fixed to one end portion 304A of the moving feeding guide 304 with respect to the widthwise direction of the sheet, and the nut 402b is fixed to the other end portion 304B of the moving feeding guide 304 with respect to the widthwise direction of the sheet. Each of the one end portion 304A and the other end portion 304B of the moving feeding guide 304 is positioned outside of widthwise ends of the fixed feeding guide 303, i.e., is disposed outside a passing region of the above-described maximum width size sheet. Accordingly, the moving feeding guide 304 is constituted so as not to prevent passing of the maximum width size sheet. Further, the driving motor 400M rotationally drives the spring shafts 401a and 401b and moves and drives the moving feeding guide 304 in the sheet thickness direction via the nuts 401b and 402b. By this, the controller 900 is constituted so as to be capable of controlling the driving mechanism 400 so that the path interval of the feeding passage P2 changes.

### [Control of Feeding Passage Thickness]

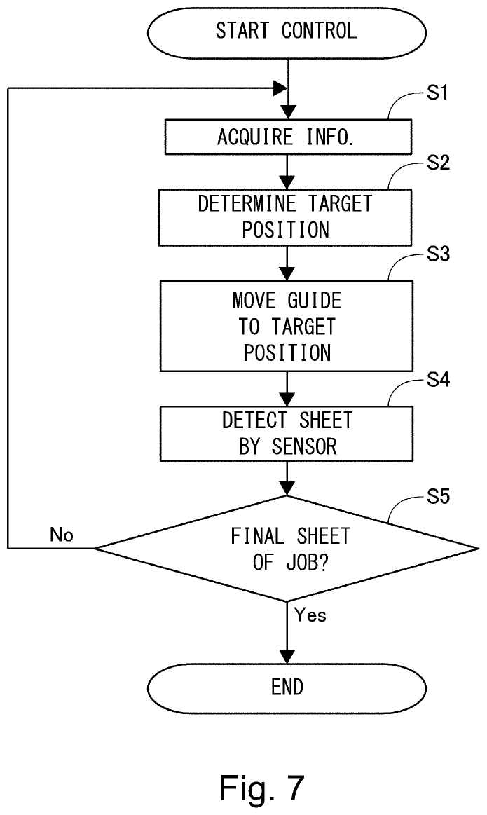

Next, control of the feeding passage thickness which is executed by the controller 900 and which is set by changing the thickness of the feeding passage P2 will be described along FIG. 7. FIG. 7 is a flowchart showing the feeding passage thickness control according to the first embodiment.

When the feeding passage thickness control according to the first embodiment is started, first, the controller 900 acquires sheet thickness information which is information on the thickness of the sheet 110 (S1). This sheet thickness information is acquired by detecting the thickness of the sheet 110 when the sheet 110 passes through a detecting position of the above-described sheet thickness sensor 118.

Next, the controller 900 determines the thickness of the feeding passage P2 (target position of the moving feeding guide 304) which is a target, depending on the sheet thickness information (S2). Then, the controller 900 drives the driving motor 400M of the driving mechanism 400, and thus moves the moving feeding guide 304 to the target position (S3). Thus, if the sheet 110 is, for example, thin paper of 0.1 mm in thickness, the thickness of the feeding passage P2 is set at 1.5 mm corresponding to an initial position as shown in FIG. 4B. Further, if the sheet 110 is, for example, thick paper of 1.0 mm in thickness, the thickness of the feeding passage P2 is narrowed from 1.5 mm, which corresponds to the initial position, to 0.3 mm, i.e., is set at a small value as shown in FIG. 4C. Then, when the leading end of the sheet 110 reaches the detecting position of the timing sensor 116, the sheet 110 is detected by the timing sensor 116 (S4).

At this time, even when the sheet 110 is, for example, the thin paper and is curled, an error between a length of the sheet 110 fed until the leading end of the sheet 110 reaches from the nip 301N of the registration roller pair 301 to the detecting position 116p of the timing sensor 116 and the distance L between the nip 301N and the detecting position 116p is suppressed to a small value. The controller 900 controls the registration motor 301M on the basis of a detection timing of this sheet 110, and adjusts a timing when the feeding speed of the sheet 110 by the registration roller pair 301 is lowered. That is, a timing when the leading end (image formation start position) of the sheet 110 reaches the transfer portion 330 is conformed to a timing when the toner image formed on the intermediary transfer belt 106 reaches the transfer portion 330.

Thereafter, the controller 900 discriminates whether or not the sheet 110 of which leading end is detected by the timing sensor 116 is final sheet of a job (S5), and when the sheet 110 is not the final sheet (No of S5), the sequence is returned to the step S1, and the above-described control is repeated. Further, when the sheet 110 of which leading end is detected by the timing sensor 116 is the final sheet (Yes of S5), the feeding passage thickness control is ended.

### Summary of First Embodiment

As described above, in the case where the sheet input information is a thickness (first thickness) of the thick paper, the path interval (distance with respect to the thickness direction) of the feeding passage P2 is made a large distance (first distance). On the other hand, in the case where the sheet input information is a thickness (second thickness) of the thin paper thinner than the thickness (first thickness) of the thick paper, the path interval of the feeding passage P2 is made a small distance (second distance). By this, although even when the sheet is a thick sheet, a jam is not readily caused to occur and the image formation is enabled, even when the sheet is a thin sheet, the position of the leading end of the sheet can be detected with accuracy.

Incidentally, in the image forming apparatus 100 of this embodiment, there is a place where the sheet feeding passage is curved, and in order to reduce a feeding resistance when the thick sheet such as the thick paper high in rigidity is fed, basis setting of the path interval is made not less than 1.5 mm which is sufficiently larger than the sheet thickness. Thereafter, in order to increase the number of kinds of sheets which can be met by the image forming apparatus 100, in the case where a sheet which is further thick and which is further high in rigidity is fed, there is a need to further increase the path interval. Further, when the path interval is made larger than 1.5 mm even in the feeding passage P2 between the detecting position 116p of the timing sensor 116 and the nip 301N of the registration roller pair 301, the influence of flexure and curl of the thin sheet becomes large. For that reason, there is a liability that a positional deviation between the toner image and the sheet becomes large. However, as in the first embodiment, in the case where the path interval of the feeding passage P2 is changed depending on the thickness of the sheet, the path interval is made small particularly when the sheet is the thin sheet, whereby the above-described positional deviation can be made small. Further, particularly when the sheet is the thick sheet, by increasing the path interval, a degree of the occurrence of the jam is reduced, so that feeding of the sheet is enabled. In summary, the image forming apparatus 100 is capable of meeting either of the thick sheet and the thin sheet.

Further, in the first embodiment, continuous and accurate positioning is enabled by supporting the moving feeding guide 304 by the direct-acting mechanisms 401 and 402 which are the ball screw mechanisms and then by stopping the moving feeding guide 304 at the target position by driving the moving feeding guide 304 with the driving motor 400M. Enabling of the continuous positioning means that an optimum path interval is always set continuously when the thickness of the sheets can be detected one by one. For example, in this case, a variation in detection accuracy of the position of the leading end of the sheet can be further reduced than in the case where the path interval is set stepwise on the basis of a sheet basis weight range of print setting set by the image forming apparatus 100. Incidentally, the use of the ball screw mechanisms requires many accurate component parts, and therefore is liable to become expensive, but allows positioning with accuracy. In the first embodiment, the direct-acting mechanisms 401 and 402 which are the ball spring mechanisms are provided at two positions, but a single direct-acting mechanism is provided, or direct-acting mechanisms may also be disposed at three or more positions.

Incidentally, a method in which the path interval is narrowed by using a thin member (flexible member) made of a resin material or in which a variation in attitude of paper would be considered as an alternate technique. However, in general, compared with a zinc-plated steel plate or a stainless plate which form a feeding surface, the resin member is low in durability and is not suitable particularly for a purpose of commercial printing in which the number of sheets printed is large. Further, the flexible member can only rectify the sheet only at a part of the path interval, and thus is not suitable for the case where the sheet is intended to be widely rectified in a region on a side upstream of the detecting position 116p of the timing sensor 116 with respect to the sheet feeding direction. In the first embodiment, on the side upstream of the detecting position 116p with respect to the feeding direction, the sheet can be rectified long particularly with respect to the feeding direction, so that accuracy when the timing sensor 116 detects the leading end of the sheet 110 can be made satisfactory.

Further, in the first embodiment, the sheet thickness information is acquired by the sheet thickness sensor 118, and the path interval is adjusted by using the information, but a thickness detecting method is not limited to the detection with the use of the sheet thickness sensor 118. That is, the sheet thickness information may also be acquired on the basis of input of information on the kind of the sheet by the user through the operating portion 180 or on the basis of input of information on the kind of the sheet by the user in the external computer via the external interface (I/F) 189. Specifically, for example, a set value of the sheet basis weight range set during printing may also be utilized.

In this case, a relationship between the thickness and the basis weight of the sheet is set in advance, and then the path interval is set depending on the inputted basis weight.

### Second Embodiment

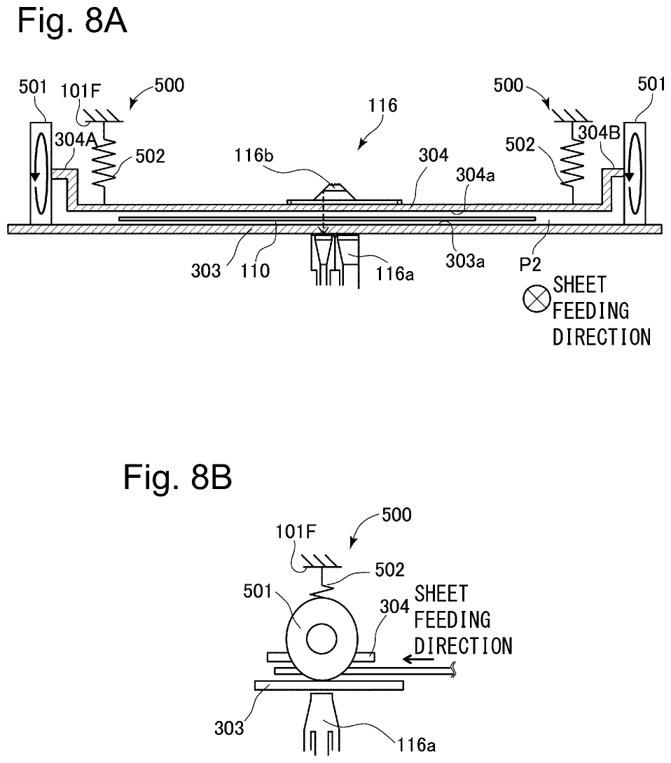

Then, a second embodiment in which the first embodiment is partially changed will be described using FIGS. 8A and 8B. FIG. 8A is a sectional view showing a state in which a fixed feeding guide and a moving feeding guide in a position of a timing sensor according to the second embodiment are viewed in the sheet feeding direction. FIG. 8B is an enlarged schematic view showing a state in which a driving mechanism according to the second embodiment is viewed on the widthwise direction of the sheet. Incidentally, in the description of the second embodiment, portions similar to those in the above-described first embodiment are represented by using the same reference numerals or symbols, and description thereof will be omitted.

In the second embodiment, compared with the above-described first embodiment, the driving mechanism for the moving feeding guide 304 is changed. Specifically, as shown in FIG. 8A and FIG. 8B, a driving mechanism 500 as the driving portion includes cams 501 and 501 rotatably supported by one end portion 304A and the other end portion 304B, respectively, of the moving feeding guide 304 and includes springs 502 and 502 as urging portions. each of the springs 502 and 502 is compressedly provided between a frame 101F and the moving feeding guide 304 and urges the moving feeding guide 304 toward the fixed feeding guide 303. Further, each of the cams 501 and 501 driven by the driving motor 400M is formed in an elliptical shape at an outer peripheral surface thereof contacting the fixed feeding guide 303. That is, the cams 501 and 501 are positioned while being rotationally driven by the driving motor 400M, so that the moving feeding guide 304 is moved away from the fixed feeding guide 303 against the urging force of the springs 502 and 502.

In summary, the driving motor 400M and the cams 501 and 501 move and drive the guide surface 304a relative to the guide surface 303a, so that the guide surface 304a is driven in a direction away from the guide surface 303a.

The controller 900 designates a rotation angle of the cams 501 and 501 by controlling the driving motor 400M. Then, in conformity to a diameter of the cams 501 and 501, the position of the guide surface 304a of the moving feeding guide 304 relative to the guide surface 303a of the guide surface 303a, i.e., the path interval is set so as to be freely changed. The cams 501 and 501 are processed with accuracy, so that the path interval can be positioned with accuracy. Incidentally, compared with the driving mechanism 400 according to the first embodiment, there is a limit to formation of the cams 501 and 501 in a for stably positioning the cams 501 and 501 in height, and further, there is a liability that the cam shafts and the moving feeding guide 304 themselves are flexed by the springs 502 and 502 or the like. However, a constitution which is more inexpensive than in the case where the mechanism such as the ball screws is used.

Incidentally, constitutions, actions, and effects other than this in the second embodiment are similar to those in the above-described first embodiment, and therefore, will be omitted from description.

### Third Embodiment

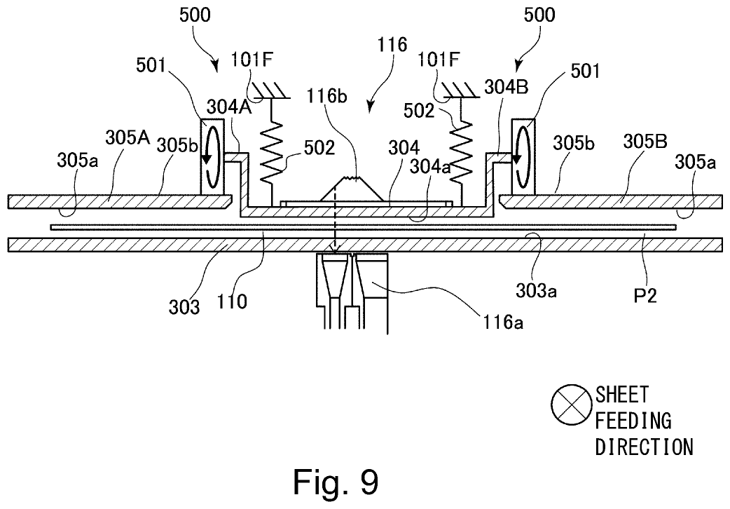

Then, a third embodiment in which the second embodiment is partially changed will be described using FIG. 9. FIG. 9 is a sectional view showing a state in which a fixed feeding guide and a moving feeding guide in a position of a timing sensor according to the third embodiment are viewed in the sheet feeding direction. Incidentally, in the description of the third embodiment, portions similar to those in the above-described first and second embodiments are represented by using the same reference numerals or symbols, and description thereof will be omitted.

In the third embodiment, compared with the above-described second embodiment, as shown in FIG. 9, a length of the moving feeding guide 304 with respect to the widthwise direction of the sheet is made smaller than the above-described maximum width size. Further, on opposite sides of the moving feeding guides 304 with respect to the widthwise direction, fixed feeding guides 305A and 305B each including a guide surface 305a which is disposed opposed to the guide surface 303a and which is a third guiding surface forming the feeding passage P2 are provided, respectively. These fixed feeding guides 305A and 305B are fixed immovably to the frame 101F on an inside of the image forming apparatus 100. Further, outer peripheral surfaces of the cams 501 and 501 of the driving mechanism 500 are constituted so as to contact outer surfaces 305b and 305b opposite from the guide surfaces 305a and 305a of the fixed feeding guides 305A and 305B, not the fixed feeding guide 303.

In summary, the driving motor 400M and the cams 501 and 501 move and drive the guide surface 304a relative to the guide surface 303a, so that the guide surface 304a is driven in a direction away from the guide surface 303a, so that the path interval is set so as to be freely changed.

For example, in the first and second embodiments, the path interval is set in an entire area with respect to the widthwise direction of the sheet. For this reason, for example, in the case where a narrow path interval such as 0.3 mm is set in conformity to the thin paper, the feeding resistance of the sheet 110 is increased. Further, there is a possibility that the path interval is easily changed by the influence of flatness, distortion during installation, and the like of component parts constituting the guide surfaces 303a and 304a and the path interval becomes excessively narrow, and thus non-feeding of the sheet, scars on the sheet, and the like occur.

In the third embodiment, an attitude of a portion of the sheet 110 overlapping with the detecting position 116p of the timing sensor 116 with respect to the widthwise direction of the sheet as viewed in the sheet feeding direction may only be required to be rectified (regulated). In other words, the attitude of the portion of the sheet 110 along the sheet feeding direction may only be required to be rectified. For that reason, there is no need to move the guide surface 304a in the entire area with respect to the widthwise direction, and as shown in FIG. 9, the guide surface 304a is moved in a range of a peripheral region (a width of about 70 mm including the detecting position 116p in this embodiment) in which the detecting position 116p of the timing sensor 116 exists. On the other hand, the guide surfaces 305a and 305a are fixed in the large path interval as they are. By this, it is possible to improve the detection accuracy of the timing sensor 116 at the same level as the level in the case where the guide surface 304a is moved in the entire area (region of not less than the maximum width size) with respect to the widthwise direction as in, for example, the second embodiment). Further, as in this embodiment (third embodiment), narrowing of the path interval at a part of the widthwise direction is capable of reducing the feeding resistance because the path interval (at the guide surfaces 305a and 305a) in other regions is large. Further, for example, compared with the second embodiment, a reference (surface) for positioning the guide surface 304a is changed from the guide surface 303a to the outer surfaces 305b, and therefore, although there is a liability that the positioning accuracy of the path interval lowers, downsizing can be realized.

Incidentally, constitutions, actions, and effects other than this in the third embodiment are similar to those in the above-described first and second embodiments, and therefore, will be omitted from description.

### Other Embodiments

Incidentally, in the above-described first to third embodiments, the constitutions in which the detection accuracy of the timing sensor 116 for detecting the timing when the leading end of the sheet 110 reaches the transfer portion 330 is improved were described. However, the present invention is not limited thereto, and if a place where there is a need to accurately detect the position of the leading end of the sheet exists inside the image forming apparatus, the moving feeding guide may also be provided in any place. For example, a constitution in which oblique movement correction is made by abutting the sheet against the registration roller pair and thus by forming flexure of the sheet and in which the timing sensor is disposed upstream of the registration roller pair with respect to the sheet feeding direction for detecting the rotation start timing of the registration roller pair may also be employed.

In this case, a structure for adjusting the path interval of the feeding passage by the moving feeding guide may only be required to be disposed on a side upstream of the timing sensor with respect to the sheet feeding direction.

Further, in the detecting first to third embodiments, the constitutions in which the structure for adjusting the path interval of the feeding passage by the moving feeding guide is disposed on the side upstream of the timing sensor with respect to the sheet feeding direction and accurately detects the leading end of the sheet were described. However, the present invention is not limited thereto, and the structure for adjusting the path interval of the feeding passage by the moving feeding guide is disposed on a side downstream of the timing sensor with respect to the sheet feeding direction and may also accurately detect the trailing end of the sheet. In this case, an accuracy-improving effect is achieved for the sheet which causes the curl at the trailing end of the sheet.

Further, in the above-described first to third embodiments, the constitutions in which the image forming apparatus is the so-called laser printer in which the image forming portion forms the image in the electrophotographic type were described. However, the present invention is not limited thereto, and for example, the image forming apparatus may also be an ink jet printer or the like, in which the image forming portion forms the image in any manner.

Further, in the above-described first to third embodiments, the constitutions in which in order to adjust the path interval of the feeding passage P2, the moving feeding guide is moved in the sheet thickness direction relative to the fixed feeding guide 303 were described. However, the present invention is not limited thereto, and a constitution in which both feeding guides are movable may also be employed. Further, the direction of the movable feeding guide is not required to be a direction perpendicular to the guide surface, and for example, a constitution in which the path interval is adjusted by linearly moving the feeding guide in a direction inclined relative to the guide surface or by moving the feeding guide along an arcuate portion may also be employed.

Further, in the above-described first to third embodiments, the constitutions in which the timing sensor 116 detects the leading end of the sheet 110 fed by the registration roller pair 301 were described. However, the present invention is not limited thereto, and the sheet feeding portion may also be any sheet feeding portion for feeding the sheet, such as a conveying roller, a feeding roller, a transfer roller, and a fixing roller.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-005876 filed on Jan. 18, 2021, which is hereby incorporated by reference herein in its entirety.

What is claimed is:

1. An image forming apparatus comprising:
an image forming portion configured to form an image on a sheet;
a sheet feeding portion configured to feed the sheet toward said image forming portion;
a first guiding member provided between said sheet feeding portion and said image forming portion with respect to a feeding direction of the sheet and including a first guiding surface for guiding the sheet;
a second guiding member configured to form a sheet feeding passage in which the sheet passes, by being provided opposed to said first guiding member and including a second guiding surface for guiding the sheet;
a driving portion configured to movably drive said first guiding member so that a distance in said sheet feeding passage with respect to a thickness direction of the sheet changes;
a detecting portion provided downstream of said sheet feeding portion with respect to the feeding direction and configured to detect a leading end of the sheet at a detecting position; and
a controller configured to control a time until the leading end of the sheet reaches from the detecting position of said detecting portion to said image forming portion by controlling said sheet feeding portion on the basis of a detection result of the leading end of the sheet by said detecting portion,
wherein when the leading end of the sheet is detected by said detecting portion,
in a case that information on a thickness of the sheet fed by said sheet feeding portion is a first thickness, said controller controls said driving portion so that the distance in said sheet feeding passage with respect to the thickness direction is a first distance, and
in a case that the information on the thickness of the sheet fed by said sheet feeding portion is a second thickness thinner than the first thickness, said controller controls said driving portion so that the distance in said sheet feeding passage with respect to the thickness direction is a second distance shorter than the first distance.

2. An image forming apparatus according to claim 1, wherein said controller controls the time until the leading end of the sheet reaches from the detecting position to said image forming portion by changing a feeding speed of the sheet by said sheet feeding portion on the basis of the detection result of the leading end of the sheet by said detecting portion.

3. An image forming apparatus according to claim 2, wherein said image forming portion includes a transfer portion configured to transfer the is image onto the sheet and a fixing portion configured to fix the image, transferred on the sheet, on the sheet, and
wherein said controller controls a time until the leading end of the sheet reaches from the detecting portion to said transfer portion by controlling said sheet feeding portion on the basis of the detection result of the leading end of the sheet by said detecting portion.

4. An image forming apparatus according to claim 3, wherein said first guiding surface is disposed on an image surface side where the image is formed by said image forming portion, and said second guiding surface is disposed on a non-image surface side where the image is not formed by said image forming portion, and
wherein said second guiding member is disposed immovably relative to said first guiding member.

5. An image forming apparatus according to claim 4, wherein said first guiding surface is disposed so as to overlap with the detecting position with respect to a widthwise direction perpendicular to the feeding direction as viewed in the feeding direction, and
wherein a distance of said first guiding surface with respect to the widthwise direction is smaller than a maximum width size of the sheet, with respect to the widthwise direction, feedable by said sheet feeding portion.

6. An image forming apparatus according to claim 5, further comprising a third guiding member including a third guiding surface which is provided side by side with said first guiding surface in the widthwise direction, which is disposed opposed to and immovably relative to said second guiding surface, and which is configured to guide the sheet.

7. An image forming apparatus according to claim 6, wherein said driving portion moves said first guiding surface relative to said second guiding surface and said third guiding surface.

8. An image forming apparatus according to claim 7, further comprising an urging portion configured to urge said first guiding surface of said first guiding member toward said second guiding surface,
wherein said driving portion moves said first guiding member in a direction in which said first guiding surface is moved away from said second guiding surface.

9. An image forming apparatus according to claim 4, wherein a size of said first guiding surface with respect to a widthwise direction perpendicular to the feeding direction is larger than a maximum width size of the sheet, with respect to the widthwise direction, feedable by said sheet feeding portion.

10. An image forming apparatus according to claim 9, wherein said driving portion is provided outside a position where the sheet with the maximum width size with respect to the widthwise direction perpendicular to the feeding direction is fed.

11. An image forming apparatus according to claim 10, wherein said driving portion moves said first guiding surface relative to said second guiding surface.

12. An image forming apparatus according to claim 10, further comprising an urging portion configured to urge said first guiding surface of said first guiding member toward said second guiding surface,
wherein said driving portion moves said first guiding member in a direction in which said first guiding surface is moved away from said second guiding surface.

13. An image forming apparatus according to claim 1, wherein said sheet feeding portion includes a first roller and a second roller for forming a nip in contact with each other, and
wherein as viewed in the widthwise direction perpendicular to the feeding direction, said second guiding surface is inclined with respect to a tangential line contacting said first roller in the nip so that a downstream end portion thereof with respect to the feeding direction is positioned on one side relative to the tangential line and an upstream end portion thereof with respect to the feeding direction is positioned on the other side relative to the tangential line and so that the nip is positioned on a sheet feeding passage side.

14. An image forming apparatus according to claim 13, wherein said transfer portion is disposed on said one side relative to the tangential line as viewed in the widthwise direction.

15. An image forming apparatus according to claim 1, further comprising a thickness detecting portion provided upstream of said sheet feeding portion with respect to the feeding direction of the sheet and configured to detect the thickness of the sheet,
wherein said controller uses, as information on the thickness of the thickness of the sheet, the thickness of the sheet detected by said thickness detecting portion.

16. An image forming apparatus according to claim 1, further comprising a receiving portion configured to receive information on a kind of the sheet inputted by a user,
wherein said controller uses, as information on the thickness of the sheet, information of the thickness of the sheet based on the information on the kind of the sheet received by said receiving portion.
